(19) United States
(12) Patent Application Publication
(10) Pub. No.: US 2002/0147929 A1
(43) Pub. Date: Oct. 10, 2002

(54) Access control for distributed content servers

(76) Inventor: Mark E. Rose, Mt.View, CA (US)

Correspondence Address: SAWYER LAW GROUP LLP, P.O. Box 51418, Palo Alto, CA, 94303, US

(21) Appl. No.: 09/832,683

(22) Filed: Apr. 10, 2001

(51) Int. Cl. H04L 9/32

(52) U.S. Cl. 713/201

(57) ABSTRACT

A method and system for controlling access to file on a server over a network is disclosed. The method and system include allowing a content originator to publish a file on a first server and to specify what users are authorized to access to file, where the files on a first server are replicated to a second server. In response to receiving a URL request from a client for a file from the first server, it is determined if a user of the client has been granted authorization to access the file. If the user has been granted authorization access, a ticket is generated that includes an identifier identifying the particular file on the second server. The method and system further include creating a redirect URL ticket to the file on the second server by modifying the client's URL request to identify the second server, and augmenting the URL request with the ticket authorizing access to the particular file. The redirect URL ticket is returned to the client, such that the client uses the redirect URL to request the file from the second server.

### FIELD OF THE INVENTION

The present invention relates to distributed publishing networking environments, and more particularly to a method and system for controlling user access to files and services in a distributed publishing network.

### BACKGROUND OF THE INVENTION

In distributed computing environments, an entity may provide services to client devices using multiple servers. One main concern in such an environment is security. That is each server must verify the identity of the user (authentication), and verify that the user has permission to view the content (authorization). One approach at providing such access control is to provide each server with access to the same authentication and authorization information.

The disadvantages with this approach, however, is that it requires either that each server communicate with a central repository of this authentication and authorization information, or that all authentication and authorization information be duplicated on all the servers. A further disadvantage is that the client would have to re-authenticate itself every time the client attempted to access the services of a different server.

A network authentication protocol, referred to as Kerberos, provides an improved access control scheme for client/server applications in a distributed computing environment. The concept behind the Kerberos protocol will first be explained by way of a real-life example in which access to a classified government building needs to be controlled. The building may have several entrance gates, each staffed by guards. It is important for the guards to be able to identify who has been authorized for entry in order to allow access to the building by legitimate employees, while keeping out intruders. It is impractical, however, for the guards to look up each person's information in some central registry each time a person wishes to gain access. Therefore, each employee might be issued an ID badge with the employee's photo. The guards may then compare the photo on the badge to the person presenting the badge when the person wishes to gain access to the building.

In this example, the ID badge has been created by some trusted authority (the security office), and is presumed tamper-resistant. The issuing authority screens people carefully to be sure they should be allowed access, and then issues the ID badges. The guards only need to check the ID badges, verifying that the badges have not been tampered with. The Kerberos protocol is conceptually similar.

FIG. 1 is a block diagram illustrating the use of Kerberos protocol in a conventional client/server network environment. The Kerberos protocol was designed to work in a network environment where users of desktop computers running special client applications 10 request various services from one or more servers 12. An example is a network run by a university, where students may access university services, such as e-mail and library services provided by e-mail and library servers, respectively.

The Kerberos protocol allows users to gain access to the remote services without having to re-authenticate for each attempted access and without requiring the remote servers 12 to share authentication information. The Kerberos protocol accomplishes this through the use of a ticket granting server (TGS) 14, which issues tickets 16 to clients 10 requesting services from a remote server 12. Each ticket 16 contains a user ID of the user, an IP address of the client 10, a time duration of the ticket 16, the service the ticket is issued for, and a digital signature of the ticket granting server 14. After receiving the ticket 16 from the ticket granting server 14, the client 10 then presents the ticket 16 to the remote server 12. The remote server 12 verifies the digital signature of the ticket 16 and allows the client 10 access to the remote server 12.

As a more in-depth example, consider the university network where a user named Alice wants to access her mailbox on the mail server. Alice and her mail client application proceed as follows: Alice logs into the ticket granting server 14 with a user name and password. The ticket granting service 14 sends the client a ticket 16 called T_{TGS} for further access. Alice activates her mail client application to check for new e-mail. The mail client application then asks the ticket granting service for a ticket to access Alice's mailbox, sending T_{TGS}, the ticket received earlier. The ticket granting server responds with the ticket for Alice's mailbox, T_{MBX}. The mail client application then connects to the mail server and sends T_{MBX} along with a request to access the email messages. The mail server verifies the T_{MBX} and sends the new messages in Alice's mailbox back to the mail client application for display.

The advantage of the Kerberos protocol is that it allows users to gain access to the remote services without having to re-authenticate for each attempted access. In addition, the Kerberos protocol requires neither active communication between the remote server and the ticket granting server, nor requires the servers 12 and 14 to share authorization information. Nevertheless, the Kerberos protocol has several disadvantages.

One disadvantage is that the Kerberos protocol requires software customized to implement the protocol on all three machines, the client 10, the ticket granting server 14, and the remote server 12. Therefore, popular desktop applications, such as e-mail applications and web browsers, must be customized and installed on user's computers before users can interact with services that support the Kerberos protocol.

Another disadvantage is that although the Kerberos tickets may effectively authenticate a user, they fail to provide adequate authorization, except at a very high-level. A Kerberos ticket may authorize a user to access a particular server, or a particular service offered by the server, but more commonly a server may store a large amount of content or offer more than one service, and not all users may be authorized to access all the content or all the services.

For example, an increasingly popular way to distribute documents (textual documents, images, multimedia files, etc.) is over the World-Wide Web, or simply the Web, where a large number of document files are distributed among a large number of servers. These servers respond to requests from client software such as Web browsers and multimedia players, and return the content files requested. To serve a large number of clients simultaneously, document files from a variety of content servers are often replicated among multiple servers, called replica servers. Client requests for particular URLs from the content servers may be routed or redirected to an appropriate replica server. For some documents or sets of documents it is important to restrict access to those users who have the privileges to view the content. In this case a server must do two things: 1) verify the identity of the user (authentication), and 2) verify that the user has permission to view the content at the desired URL (authorization).

Unfortunately, the Kerberbos protocol has no provision for handling URL requests from clients. And even if it did, each remote server 12 in a Kerberbos system would still have to manage what content a particular user could access. This means that authorization logic must be duplicated in each remote server 12 in a network, or the logic must be shared by all the remote servers 12. This may be impractical when the servers are geographically or topologically separated, or controlled by different entities that may not wish to divulge the details of the authorization information. A further disadvantage of the Kerberos protocol is that the Kerberos protocol fails to address network address translation (NAT), and therefore has limited network applications.

Accordingly, what is needed is an improved network access control process. The process should handle URL requests, control user access to distributed content on remote servers, and address NAT. The present invention addresses such a need.

### SUMMARY OF THE INVENTION

The present invention provides a method and system for controlling access to files on a server over a network. The method and system include allowing a content originator to publish a file on a first server and to specify what users are authorized to access to file, where the files on a first server are replicated to a second server. In response to receiving a URL request from a client for a file from the first server, it is determined if a user of the client has been granted authorization to access the file. If the user has been granted authorization access, a ticket is generated that includes an identifier identifying the particular file on the second server. The method and system further include creating a redirect URL ticket to the file on the second server by modifying the client's URL request to identify the second server, and augmenting the URL request with the ticket authorizing access to the particular file. The redirect URL ticket is returned to the client, such that the client uses the redirect URL to request the file from the second server.

According to the system and method disclosed herein, access control to files and services is provided that handles the URL requests from standard client software, both authenticates the user, and verifies that the user has the authority to view the content at a particular URL. In addition, neither active communication between the first server and the second server is required, nor is the duplication of authentication and access control information on both the first server and the second server, all without the use of customized client software.

### BRIEF DESCRIPTION OF THE DRAWINGS

FIG. 1 is a block diagram illustrating the use of Kerberos protocol in a conventional client/server network environment.

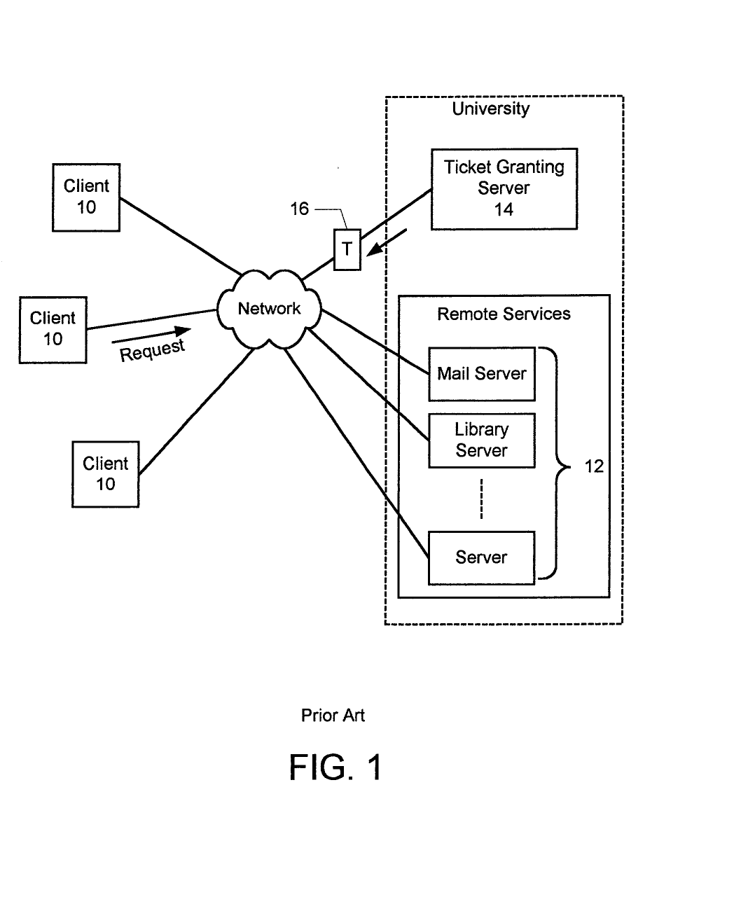

FIG. 2 is a block diagram illustrating a distributed publishing network environment for use in accordance with the present invention.

FIG. 3 is a flow chart illustrating a process for controlling access to files in a distributed publishing environment in accordance with one preferred embodiment of the present invention.

FIG. 4 is a flow diagram illustrating the process of a content originator publishing content and setting access controls on the content server.

FIG. 5 is a diagram illustrating a set of parameters used in the URL ticket in a preferred embodiment of the present invention.

FIG. 6 is a flow diagram of a request flow when a transfer ticket is used.

### DETAILED DESCRIPTION

The present invention relates to access control methods in a distributed publishing environment. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

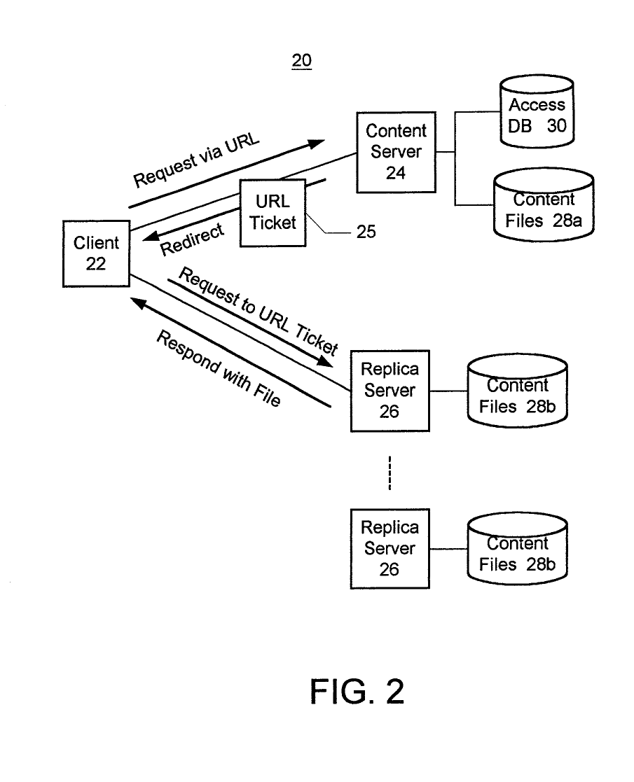

FIG. 2 is a block diagram illustrating a distributed publishing network environment for use in accordance with the present invention. The publishing network 20 includes multiple client devices 22, at least one content server 24, and one or more replica servers 26.

As used herein, a client 22 is a software application running on a computer for a user in order to gain access to content files 28a stored on the content server 24. In a preferred embodiment, the client 22 is a standard web browser, although the client 22 may also represent a document editing program, a multimedia player, or any other program that creates and/or opens electronic files.

The content server 24 is a computer system running web server software or other server software that responds to requests from the clients 22 by serving the files requested to clients 12 over a network, such as the Internet. The files 28a served by the content server 24 may reside on the same computer system as the content server 24 or in an external database.

To serve a large number of clients 22 simultaneously, the files 28a from the content servers 24 are often replicated among the replica servers 26. Client requests for particular URLs from the content server 24 may be routed or redirected to the appropriate replica server 26 based on algorithms using randomization, considerations of server load, considerations of network topology, or other means. The content server 24 and the replica servers 26 may be thought of collectively as a distributed content repository.

The clients 22 communicate with the servers and 24 and 26 over a variety of Internet application protocols including HyperText Transport Protocol (HTTP), File Transfer Protocol (FTP), RealTime Streaming Protocol (RTSP), and Microsoft Media Services (MMS). The clients 22 request particular content files 28a by providing the URL (uniform resource locator), or address, of the files 28a on the content server 24.

Each client 22 in a network 20 has a network address. In the Internet, this address is the client's IP address. Each request from a client 22 to a server in the Internet is transported to the server using a network protocol such as the Transmission Control Protocol (TCP) or the User Datagram Protocol (UDP). When using these protocols, it is normally possible for the server to determine the client's IP address. Under some conditions the client's IP address is not stable over time, for example when the Dynamic Host Configuration Protocol (DHCP) is used. In other cases a client's request may pass through a network router or proxy server which causes the IP address of the client apparent to the server to differ from the client's actual IP address at the time the request was initiated. This is known as address translation (NAT).

The present invention addresses the problem of restricting access in the distributed publishing network 20 to those users who have the privileges to view the content in the network 20. The servers 24 and 26 need to verify the identity of the user (authentication), and verify that the user has permission to view the content at the desired URL (authorization). As stated above, this requires either that all of the servers 24 and 26 communicate with a central repository of this authentication and authorization information, or that all authentication and authorization information is replicated to all servers 24 and 26.

Both of these operations are more difficult when documents are replicated between many servers 24 and 26, because all servers must have access to the same authentication and authorization information. In addition, both operations are less practical when the content server 24 and replica servers 26 are geographically or topologically separated, as in the distributed publishing network 20. Further, in a preferred embodiment, the content server 24 is controlled by one entity, while the replica servers 26 are controlled by another, which makes the process of coordinating access control to the files 28 and services on both the content server 24 and the replica servers 26 all the more difficult because the two entities may not wish to divulge details of their authorization information to the replica servers 26.

The Kerberos protocol does not present a viable solution because it has no provisions for handling URL requests, requires the modification of client software to support the protocol, and fails to support NAT. For these reasons, another approach is desirable.

The present invention provides a method and system for controlling access to files and services in a distributed publishing environment that handles the URL requests from standard client software, authenticates the user, and verifies that the user has the authority to view the content at the desired URL. According to the method and system disclosed herein, neither active communication between the content server 24 and the replicas servers 26 is required, nor the duplication of authentication and access control information on both the content server 24 and the replica servers 26.

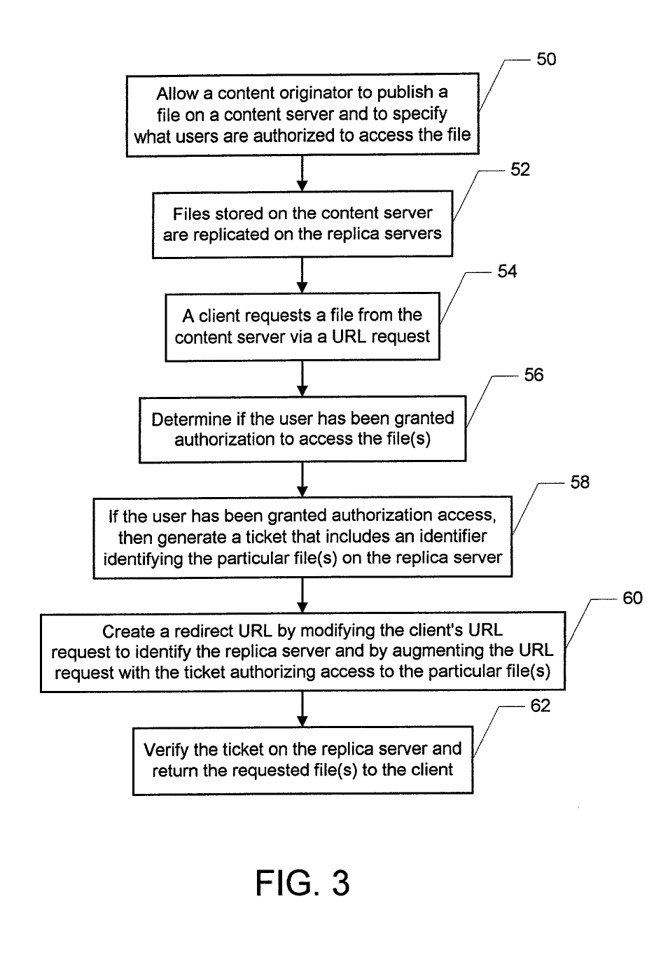

FIG. 3 is a flow chart illustrating a process for controlling access to files in a distributed publishing environment in accordance with one preferred embodiment of the present invention. The process begins by allowing a content originator to publish a file on a content server 24 and to specify what users are authorized to access the file in step 50. Thus, according to the present invention, access control is established at time of publication. Files stored on the content server 24 are replicated on the replica servers 26 in step 52.

Referring to both FIGS. 2 and 3, a client 22 may then request a file or a set of files from the content server 22 via a URL request in step 54. In response, the content server 22 determines if the user has been granted authorization to access the file(s) in step 56. If the user has been granted authorization access, then a ticket is generated that includes an identifier identifying the particular file(s) on the replica server 26 in step 58. In a preferred embodiment, the identifier is in the form of a URL, but the identifier may also be a list of file names.

The content server 24 then creates a redirect URL 25 to the file on one of the replica servers 26 by modifying the client's URL request to identify the replica server 26 and by augmenting the URL request with the ticket authorizing access to the particular file(s) in step 60. The present invention takes advantage of the fact that URLs follow the syntax of the more general “uniform resource identifiers” or URIs, that have a provision for embedding parameters into the URL which could modify the processing of the URL by a server. After the client 22 has been redirected to the appropriate replica server 26 using the redirect URL ticket 25, the replica server 26 verifies the ticket in and returns the requested file(s) to the client 22 in step 62.

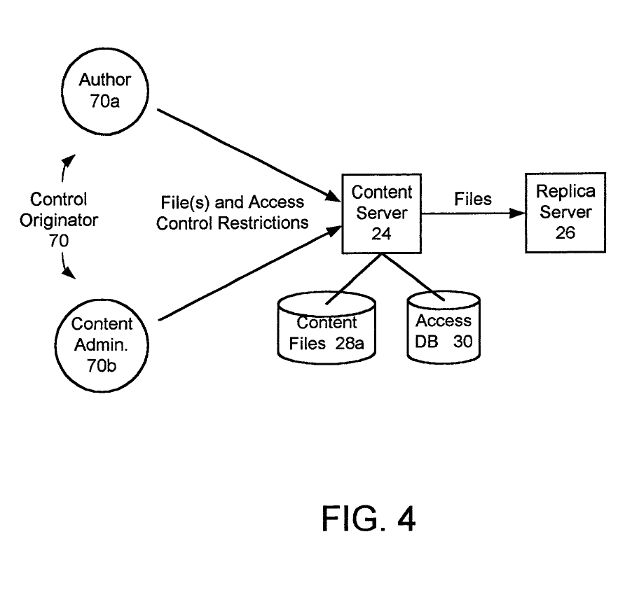

According to one aspect of the present invention, access control restrictions for the content files 28 are established at the time of publication by a content originator, as shown in FIG. 4.

FIG. 4 is a flow diagram illustrating the process of a content originator publishing content and setting access controls on the content server 22. According to the present invention, a content originator 70 may upload a file to the content server 22 for publication and set access control restrictions for the file by specifying what users are authorized to access the file. The content originator 70 may either be the file's author 70a or a content administrator 70b. In a publishing environment having multiple content servers 24, the content originator 70 may set the access controls even though the content originator 70 may not have knowledge of which content server 24 the file will be published on.

Once specified, the access controls are stored in an access control database 30, along with the name of the file(s). The access controls may specify a particular user or group of users that may access the file and also what access privileges each user or group of users has with respect to files. Access privileges may include read, write, update, and delete operations. The access controls may be specified before or after the file is replicated onto the replica server 26, but the access control restrictions are not replicated with the file.

The process of responding to a client request to access content on the content server 24 will now be explained in further detail. In one preferred embodiment, the process begins when a user launches a client 22 with a URL to the content server 24. In response, the content server 24 redirects the client 22 to a login page. The user then enters a user name and password and submits the log-in form. The content server 24 verifies the user name and password and redirects the client to content pages. The IP address of the client 22, as apparent to the server (the apparent IP address may not match the client's real IP address in the case of NAT), and the session ID are also stored at this time.

The user then browses and/or searches the content pages and clicks on a link to desired content. The client 22 sends an HTTP request for the particular content page. The content server 24 looks up the name of content page in the access control database 30 and determines if the user name has been granted access to the content page or belongs to a group that has been granted access to the content page. If the user has been granted access to the content page, then the content server generates a new URL ticket 25 to the content page on the appropriate replica server 26 and responds to the client 22 with the new redirect URL ticket 25.

In a preferred embodiment, the content server 24 generates URL tickets 25 to content that is not public on the replica servers 26 in the form:

scheme://servername/ . . . /basedir;parameters/subdir/ . . . /file.extension

where the “scheme” typically represents “http” or “https,” and the “server name” represents the DNS name of the replica server 26 The portion of the URL prefix following the server name, up to and including the basedir value, indicates the portion of the content server's or replica server's content to which access is granted by the ticket. Each parameter in the URL ticket 25 includes a parameter name and a value:

name1=value1;name2=value2; . . .

All parameter values are URL-encoded, to avoid putting “/” and other characters into the middle of the URL. These parameter names are used:

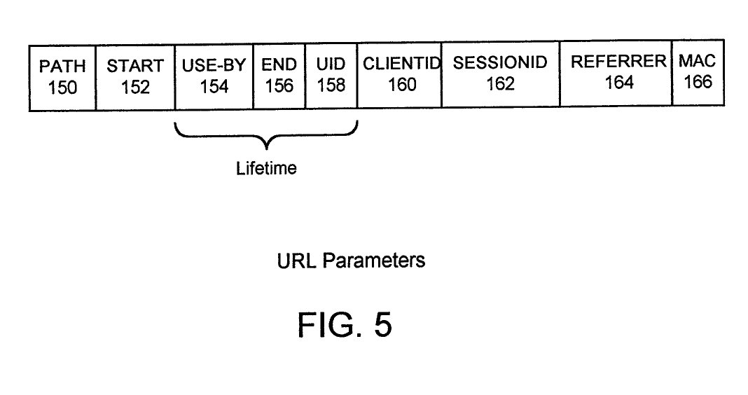

FIG. 5 is a diagram illustrating a set of parameters used in the URL ticket 25 in a preferred embodiment of the present invention. The parameters placed into the URL ticket 25 include a path parameter 150, a start parameter 152, a use-by parameter 154, an end parameter 156, a uid parameter 158, a clientid parameter 160, a sessionid parameter 162, a referrer parameter 164, and a message authentication code (MAC) parameter 166.

The path parameter 150 identifies a top-level directory that contains the content. The start parameter 152, the use-by parameter 154, and the end parameter 156 indicate the lifetime of the URL ticket 25.

The start parameter 152 is the time at which the URL becomes valid for use, preferably in seconds. The use-by parameter 154 is the time by which the URL must be used, or it will not be accepted as valid. And the end parameter 156 is the time at which the URL becomes invalid for use.

It should be noted that if the client IP address was known for which the URL ticket 25 is valid, then only the start and end parameters 154 and 156 would be sufficient. However, the network topology and/or NAT may cause the client IP address to be different for the content server 22 and the replica server 26. Therefore, the present invention “binds” the combination of “basedir+path+sessionid” to an IP address at first use of the URL ticket 25. To avoid disclosure attacks where a valid user gets a URL ticket 25 but passes it on to a third party before using it, the time before first use is restricted to a smaller value than the URL validity range. This doesn't eliminate that disclosure attack, since the first-use window needs to be large enough to account for server time differences, but it makes it harder.

The uid parameter 158 is the user ID for which the URL is valid. The clientid parameter 160 is the IP address of the client 22 that originally requested the content (i.e., the IP address at the time the content server 24 created the URL ticket 25). This may not match the client IP address when the replica server 26 gets the request, since network address translation (NAT) may be present during one or both of the URL requests (URL for the content server 22 vs. URL for the replica server 26).

The sessionid parameter 162 is the session ID for which the URL ticket 25 is valid. The session ID may be URL-encoded in case it contains embedded slashes. In a preferred embodiment, the uid and sessionid parameters 160 and 162 are only used to make it easier to correlate logs from the content server 24 and the replica servers 26. Only one of the two values may be required for log correlation, but sessionid is still required for ticket validation, as described below.

The referrer parameter 164 is a URL on the content server 24 that can be used to access the content after redirecting to the replica server 26 again—which will prompt for user authentication.

The MAC parameter 166 is the message authentication code, or digital signature, calculated on the component of the URL ticket 25 from the “basedir” to the last parameter, excluding the MAC. The MAC ensures both that the content server 22 created the URL ticket 25 and that the URL ticket 25 has not been altered. The MAC value includes both the actual MAC code and an indication of what MAC algorithm is used.

The following is an example of a URL ticket 25:

http://gfp/gforce/gfrepository/gf12345/678;start=1234567890;use-by=1234568000;end=1234000000; clientid=192.168.1.14;uid=mark;sessionid=abcdef . . . ;

mac=hmac-md5,aBcD1234+-xYzWuV . . . zZ /start.htm

In a preferred embodiment, the replica server 26 verifies and accepts a URL ticket 25 as valid only if all of the following are true:

1) The MAC is correct.

2) the current time is between “start” and “use-by,” or the “basedir+path+sessionID” combination has previously been used for the same IP address. Using the “basedir+path+sessionID” combination is a way to keep the URL ticket from being passed around from one user to another because the unique identifier for the ticket is bound to the IP address the first time it is used. Alternatively, a ticket ID could be added to the URL.

3) The “basedir+path+sessionID” combination has not been used from a different IP address, and

4) the URL requests a file that is in a subtree rooted by basedir+“/”path.

If any of these conditions is false, the replicas server 26 may redirect the client 22 back to the URL indicated by the “referrer” parameter.

As mentioned, it is important to ensure that only the client 22 that was issued the URL ticket 25 can use the URL ticket 25. The only way to ensure this without requiring additional authentication when accessing a replica server 26 is by using the IP address. However, this introduces a problem in environments where NAT is used, since one client 22 may have different apparent IP addresses when talking to the different servers 24 and 26.

According to a further aspect of the present invention, this problem is solved by using what is called a transfer ticket (like a bus transfer). A transfer ticket has a short lifetime (seconds to minutes, depending on how close clock skew between servers can be guaranteed) and is not bound to a particular IP address. A transfer can only be used to get a real ticket that is bound to one IP address.

A transfer ticket may be used whenever the content server 24 needs to redirect to a replica server 26. The replica server 26 recognizes a request from a client 22 as a transfer, and redirects the client 22 back again to the same replica server 26, but the second redirect with a URL ticket 25.

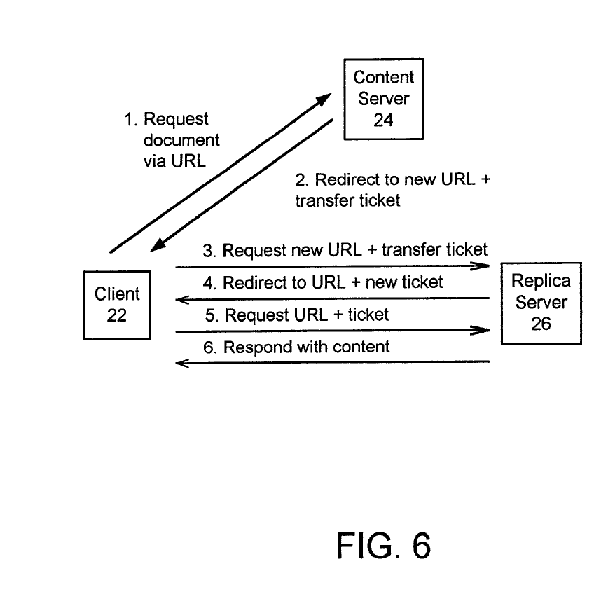

FIG. 6 is a flow diagram of a request flow when a transfer ticket is used. In this scenario, the client 22 begins by requesting a file via a URL from content server 24. The content server 24 generates a URL transfer ticket and redirects the client 22 to the replica server 26 using a URL transfer ticket. The replica server 26 generates a new URL ticket to itself and redirects the client 22 using the new URL ticket. The client 22 uses the new URL ticket to request the content, and the replica server 26 responds with the content.

A method and system for controlling user access to files and services in a distributed publishing network environment has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1 A method for controlling access to file on a server over a network, the method comprising the steps of:
(a) allowing a content originator to publish a file on a first server and to specify what users are authorized to access to file;
(b) replicating the file from the first server on a second server;
(c) in response to receiving a URL request from a client for a file from the first server, determining if a user of the client has been granted authorization to access the file;
(d) generating a ticket that includes an identifier identifying the particular file on the second server if the user has been granted authorization access;
(e) creating a redirect URL ticket to the file on the second server by
(i) modifying the client's URL request to identify the second server, and
(ii) augmenting the URL request with the ticket authorizing access to the particular file; and
(f) returning the redirect URL ticket to the client, such that the client uses the redirect URL to request the file from the second server.

2 The method of claim 1 further including the step of:
(g) verifying the ticket on the second server and returning the requested file.

3 The method of claim 1 wherein step (c) further includes the step of: using a web browser for the client, wherein the web browser has not been customized to request tickets.

4 The method of claim 1 wherein step (a) further includes the step of: allowing the content originator to specify what access privileges each user has with respect to the files, the access privileges including read, write, and delete.

5 The method of claim 4 wherein step (a) further includes the step of: allowing the access controls to be specified before and after the file is replicated onto the second server.

6 The method of claim 4 wherein step (a) further includes the steps of: storing the name of the file in a database along with access privileges specified for the file, and when a user makes a request to access the file, looking up the name of the file in the database and determining if the user has been granted access to the file.

7 The method of claim 1 wherein step (e) further includes the step of: generating the URL ticket in the form:
scheme://servername/ . . . /basedir;parameters/subdir/ . . . /file.extension.

8 The method of claim 7 wherein step (e) further includes the step of: placing into the URL ticket a path parameter, a start parameter, a use-by parameter, an end parameter, a uid parameter, a clientid parameter, a sessionid parameter, a referrer parameter, and a message authentication code (MAC).

9 The method of claim 7 wherein step (e) further includes the step of: binding a combination of “basedir+path+sessionid” to an IP address of the client at first use of the URL ticket.

10 The method of claim 9 wherein step (g) further includes the step of: verifying the URL ticket as valid when;
(i) the MAC is correct,
(ii) a current time is between values of the start and use-by parameters, or the “basedir+path+sessionID” combination has previously been used for the same IP address,
(iii) the “basedir+path+sessionID” combination has not been used from a different IP address, and
(iv) the URL requests a file that is in a subtree rooted by basedir+“/”path.

11 The method of claim 1 further including the step of: ensuring that only the client that was issued the URL ticket can use the URL ticket by
(i) issuing a transfer ticket from the first server to the client when the first server needs to redirect the client to the second server,
(ii) recognizing by the second server the transfer ticket in a request from the client,
(iii) redirecting the client back to the second server with a URL ticket, and
(iv) verifying the ticket on the second server and returning the requested file.

12 The method of claim 1 further including the step of providing a content server as the first server and providing at least one replica server as the second server.

13 A system for controlling access to file on a server over a network, the system comprising the steps of:
means for allowing a content originator to publish a file on a first server and to specify what users are authorized to access to the file, wherein files on the first server are replicated on a second server;
means responsive to receiving a URL request from a client for a file from the first server for determining if a user of the client has been granted authorization to access the file;
means for generating a ticket that includes an identifier identifying the particular file on the second server if the user has been granted authorization access;
means for creating a redirect URL ticket to the file on the second server by modifying the client's URL request to identify the second server, and augmenting the URL request with the ticket authorizing access to the particular file; and
means for returning the redirect URL ticket to the client, such that the client uses the redirect URL to request the file from the second server.

14 The system of claim 13 further including means for verifying the ticket on the second server and returning the requested file.

15 The system of claim 13 wherein the client comprises a web browser that has not been customized to request tickets.

16 The system of claim 13 wherein the content originator specifies what access privileges each user has with respect to the files, the access privileges including read, write, and delete.

17 The system of claim 16 wherein the access controls can be specified before and after the file is replicated onto the second server.

18 The system of claim 16 wherein a name of the file is stored in a database along with the access privileges specified for the file, and when a user makes a request to access the file, the name of the file is looked up in the database to determine if the user has been granted access to the file.

19 The system of claim 13 wherein the URL ticket is in the form:
scheme://servername/ . . . /basedir;parameters/subdir/ . . . /file.extension.

20 The system of claim 19 wherein the URL ticket includes a path parameter, a start parameter, a use-by parameter, an end parameter, a uid parameter, a clientid parameter, a sessionid parameter, a referrer parameter, and a message authentication code (MAC).

21 The system of claim 20 wherein a combination of “basedir+path+sessionid” is bound to an IP address of the client at first use of the URL ticket.

22 The system of claim 21 wherein the URL ticket is verified as valid when;
(i) the MAC is correct,
(ii) a current time is between values of the start and use-by parameters, or the “basedir+path+sessionID” combination has previously been used for the same IP address,
(iii) the “basedir+path+sessionID” combination has not been used from a different IP address, and
(iv) the URL requests a file that is in a subtree rooted by basedir+“/”path.

23 The system of claim 13 wherein it is ensured that only the client that was issued the URL ticket can use the URL ticket by
(i) issuing a transfer ticket from the first server to the client when the first server needs to redirect the client to the second server,
(ii) recognizing by the second server the transfer ticket in a request from the client,
(iii) redirecting the client back to the second server with a URL ticket, and
(iv) verifying the ticket on the second server and returning the requested file.

24 The system of claim 13 wherein the first server comprises a content server and the second server comprises at least one replica server.

25 A computer-readable medium containing program instructions for controlling access to file on a server over a network, the program instructions for:
(a) allowing a content originator to publish a file on a first server and to specify what users are authorized to access to file;
(b) replicating the file from the first server on a second server;
(c) in response to receiving a URL request from a client for a file from the first server, determining if a user of the client has been granted authorization to access the file;
(d) generating a ticket that includes an identifier identifying the particular file on the second server if the user has been granted authorization access;
(e) creating a redirect URL ticket to the file on the second server by
(i) modifying the client's URL request to identify the second server, and
(ii) augmenting the URL request with the ticket authorizing access to the particular file; and
(f) returning the redirect URL ticket to the client, such that the client uses the redirect URL to request the file from the second server.

26 The computer-readable medium of claim 1 further including the instruction of:
(g) verifying the ticket on the second server and returning the requested file.

27 The computer-readable medium of claim 1 wherein instruction (c) further includes the instruction of: using a web browser for the client, wherein the web browser has not been customized to request tickets.

28 The computer-readable medium of claim 1 wherein instruction (a) further includes the instruction of: allowing the content originator to specify what access privileges each user has with respect to the files, the access privileges including read, write, and delete.

29 The computer-readable medium of claim 4 wherein instruction (a) further includes the instruction of: allowing the access controls to be specified before and after the file is replicated onto the second server.

30 The computer-readable medium of claim 4 wherein instruction (a) further includes the instructions of: storing the name of the file in a database along with access privileges specified for the file, and when a user makes a request to access the file, looking up the name of the file in the database and determining if the user has been granted access to the file.

31 The computer-readable medium of claim 1 wherein instruction (e) further includes the instruction of: generating the URL ticket in the form:
scheme://servername/ . . . /basedir;parameters/subdir/ . . . /file.extension.

32 The computer-readable medium of claim 7 wherein instruction (e) further includes the instruction of: placing into the URL ticket a path parameter, a start parameter, a use-by parameter, an end parameter, a uid parameter, a clientid parameter, a sessionid parameter, a referrer parameter, and a message authentication code (MAC).

33 The computer-readable medium of claim 7 wherein instruction (e) further includes the instruction of: binding a combination of “basedir+path+sessionid” to an IP address of the client at first use of the URL ticket.

34 The computer-readable medium of claim 9 wherein instruction (g) further includes the instruction of: verifying the URL ticket as valid when;
(i) the MAC is correct,
(ii) a current time is between values of the start and use-by parameters, or the “basedir+path+sessionID” combination has previously been used for the same IP address,
(iii) the “basedir+path+sessionID” combination has not been used from a different IP address, and
(iv) the URL requests a file that is in a subtree rooted by basedir+“/”path.

35 The computer-readable medium of claim 1 further including the instruction of: ensuring that only the client that was issued the URL ticket can use the URL ticket by
(i) issuing a transfer ticket from the first server to the client when the first server needs to redirect the client to the second server,
(ii) recognizing by the second server the transfer ticket in a request from the client,
(iii) redirecting the client back to the second server with a URL ticket, and
(iv) verifying the ticket on the second server and returning the requested file.

36 The computer-readable medium of claim 1 further including the instruction of providing a content server as the first server and providing at least one replica server as the second server.

37 A URL ticket for redirecting a URL request for a file on a content server from a client to a replica server comprising:
a format in a form of
scheme://servername/ . . . /basedir;parameters/subdir/ . . . /file.extension.
where the “scheme” represents “http” or “https,” and the “server name” represents a DNS name of the replica server, and wherein each parameter in the URL ticket includes a parameter name and a value:
name1=value1;name2=value2; . . .

38 The URL ticket of claim 37 wherein the parameters include a path parameter, a start parameter, a use-by parameter, an end parameter, a uid parameter, a clientid parameter, a sessionid parameter, a referrer parameter, and a message authentication code (MAC).
